(19) United States
(12) Patent Application Publication
(10) Pub. No.: US 2011/0037544 A1
(43) Pub. Date: Feb. 17, 2011

(54) PULL SWITCH

(76) Inventors: Steve J. Tinius, Floyds Knobs, IN (US); Carol Fountain, New Albany, IN (US); John Tinius, New Albany, IN (US)

Correspondence Address: FROST BROWN TODD, LLC, 2200 PNC CENTER, 201 E. FIFTH STREET, CINCINNATI, OH, 45202, US

(21) Appl. No.: 11/942,417

(22) Filed: Nov. 19, 2007

Related U.S. Application Data
(60) Provisional application No. 60/966,536, filed on Nov. 17, 2006.

(51) Int. Cl. H01H 9/00

(52) U.S. Cl. 335/205

(57) ABSTRACT

A pull switch incorporates a magnet pickup sensing of a selected one of a pulled, return or both of a pull string. A position of reset and trip states may be varied based on configuration. Because of these features, the pull switch can be used in many applications where a fixed position switch would not apply or would be hard to incorporate into the application. It can also be used in many fixed switch applications and allow for a more accurate switching. This switch can also allow for a much simpler installation with less hardware required then a fixed position switch.

### FIELD OF THE INVENTION

The present invention relates, in general, to status indicating devices and, in particular, to a pull switch.

### BACKGROUND OF THE INVENTION

The use of cables to trip switches is a known art. Generally, such switches had to be mounted in a fixed position and were set up to detect only a pre-set change of state. The problem with such switches is that they do not allow for any variation in the switch's reset location.

### BRIEF DESCRIPTION OF THE FIGURES

The accompanying drawings, which are incorporated in and constitute a part of this specification, illustrate embodiments of the invention, and, together with the general description of the invention given above, and the detailed description of the embodiments given below, serve to explain the principles of the present invention.

FIG. 1 is a perspective view of the pull switch of the present invention;

FIG. 2 is an exploded view of the pull switch of FIG. 1;

FIG. 3 is a diagrammatic view of a pull switch in an initial, spooled condition at a counterclockwise-most position of a rotating portion of a position sensor;

FIG. 4 is a diagrammatic view of the pull switch of FIG. 3 after a pull string is drawn out causing the reed to change state because the magnet is moved from the location from which it was holding the reed in the opposite state to a wheel cam stop at a clockwise-most position;

FIG. 5 is a diagrammatic view of the pull-return switch of FIG. 11 after the pull string has been drawn out an additional amount with the rotating portion remaining stationary to set a desired operating length and set a tripped position so as to keep the magnet from tripping the reed again as this cable is continued to be pulled;

FIG. 6 is a diagrammatic view of the pull switch of FIG. 5 after the pull string has started to retract;

FIG. 7 is a diagrammatic view of the pull switch of FIG. 6 after the pull string has been allowed to retract to the counterclockwise most position indicating a return position.

FIGS. 8-13 are additional diagrammatic views of the pull switch with the pull string in various positions.

### DETAILED DESCRIPTION OF THE INVENTION

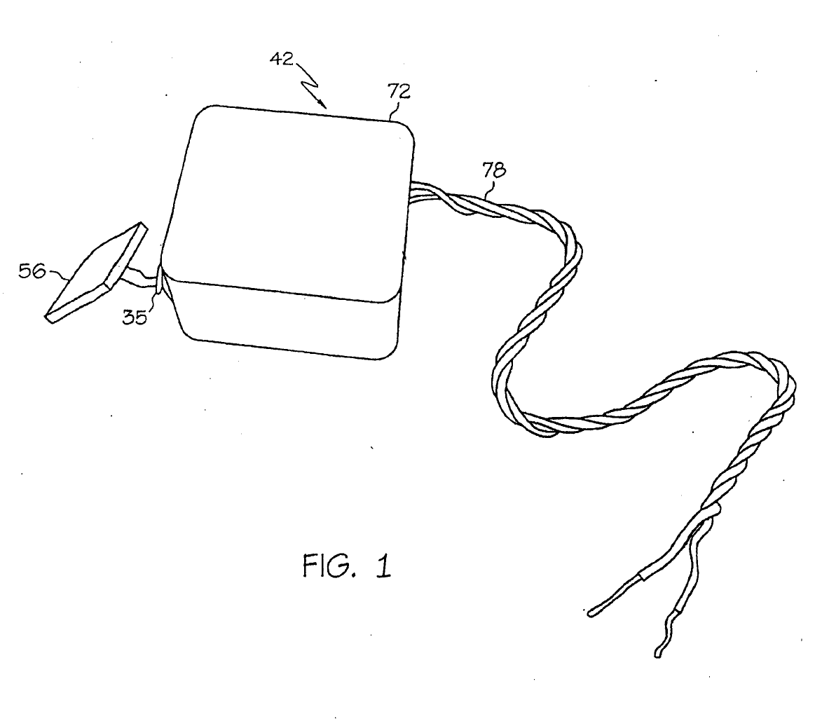

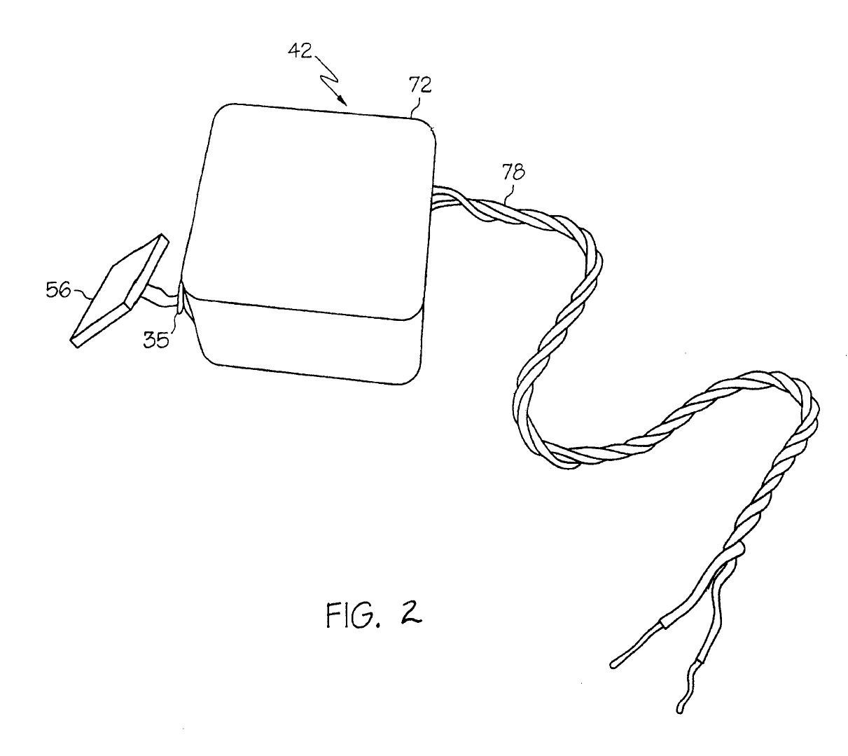

Referring to FIGS. 1-2, one version of a pull switch 42 is disclosed having a housing 72, including a top portion 74 and a bottom portion 76, a pull string 35 attached to an anchor 56, and wires 78 for the internal reed switch. A double-sided adhesive pad 79 on the housing 72 enables rapid installation. Referring to FIG. 2, the top portion 74 and bottom portion 76 of the housing 72 are adapted to receive a cable wheel assembly 82 therein. The top portion 74 may include a post 84 projecting inwardly from the central axis thereof that corresponds with a hole 86 in the bottom portion 76 for coupling the two halves of the housing 72.

An indicator (e.g., magnet) wheel 88, inserted over the post 84, is pressure loaded for frictional engagement against a cable wheel 94 by a load spring 90 (e.g., alternatively, a wave spring, PN CS050-L1, Smalley Steel Ring Company, Lake Zurich, Ill.) and a spring slide washer 92 positioned between the magnet wheel 88 and the top portion 74. The magnet wheel 88 may include a wheel cam stop 96 that corresponds to a fixed stop 98 on the top portion 74 such that, when rotated, the magnet wheel 88 is limited by the fixed stop 98. The magnet wheel 88 may further include a hole 100 in which a movable portion of a position sensor, depicted as a magnet 102, may be retained. The magnet 102 may be located adjacent to the electrical contacts in the top portion of the housing 72, depicted as a reed switch 80 such that rotation of the magnet wheel 88 operates the contacts 80. Thus, the location sensor in particular is illustrated as a magnetic sensor that avoid contacts subject to wear and degradation.

The magnet wheel 88 may be retained within the cable wheel 94 such that rotation of the cable wheel 94 correspondingly rotates the magnet wheel 88. The cable wheel 94 may be placed over the post 84 and in one version is operably configured to rotate within the housing 72. The rotation of the magnet wheel 88 may be limited by the wheel cam stop 96 on the magnet wheel 88 meeting up with the housing stop 98. The cable wheel 94 may be circular in shape and may be configured such that the pull string 35 may be wound around the circumference thereof. The pull string 35 may be coupled with (e.g., tied to) the cable wheel 94 at a pair of radially spaced through holes 105 that communicate between an outer spool or reel recess 110 and an upwardly open cylindrical recess 114 that encompasses the magnet wheel 88. The cable wheel is flipped over at 94′ to expose a central cylindrical hub portion 101 having a securing slot 104 or by any other suitable connection mechanism that receives an inner end 103 of a cable spring 106 that resides under the cable wheel 94 and has an outer end 107 that is received in a corner slot 109 that communicates with an upwardly open cylindrical recess 111 formed in the bottom portion 76 of the housing 72. Thus, rotating the cable wheel 94 clockwise as viewed from above loads the cable spring 106. After rotating the cable wheel 94 in one direction, the loaded cable spring 106 may allow the cable wheel 94 to have a return function that allows it to rotate in the opposite direction back to its starting position.

Still referring to FIG. 2, in one version, the cable wheel 94 is rotated by pulling the pull string 35 wound thereabout. The free end of the pull string 35 may pass out of the housing 72 via an eyelet 108B and notch 108A and is connected at its terminus to an anchor 56. In one version, the anchor 56 is affixed to a movable object, and the pull switch 42 are affixed to a fixed object. When the, movable object is moved away from the fixed object, the pull string 35 may be drawn out of the pull switch 42, thereby rotating the cable wheel 94 located therein. Rotating the cable wheel 94 may correspondingly rotate the magnet wheel 88 such that the magnet 102 located thereon operates the reed 80, indicating that the object has moved away from the fixed object. As the pull string 35 is pulled, the magnet wheel 88 is thus prevented from further rotation with the cable wheel 94 due to the wheel cam stop 96 abutting the fixed stop 98. Thereby, the magnet 102 does not change the state of the reed 80.

It should be appreciated that a pull switch 42 consistent with aspects of the invention may be configured such that its tripped state and reset state are appropriate for a specific application. For instance, the size of the cable wheel 94 may be varied. The portion of rotation of a magnet wheel 88 that may be traversed prior to encountering the fixed stop 98 may vary. The number and/or positioning of magnets 102 and reed switches 80 may vary in order to provide a desired reset and trip state. It can also be used in many fixed switch applications and allow for a more accurate switching. This switch can also allow for a much simpler installation with less hardware required then a fixed position switch.

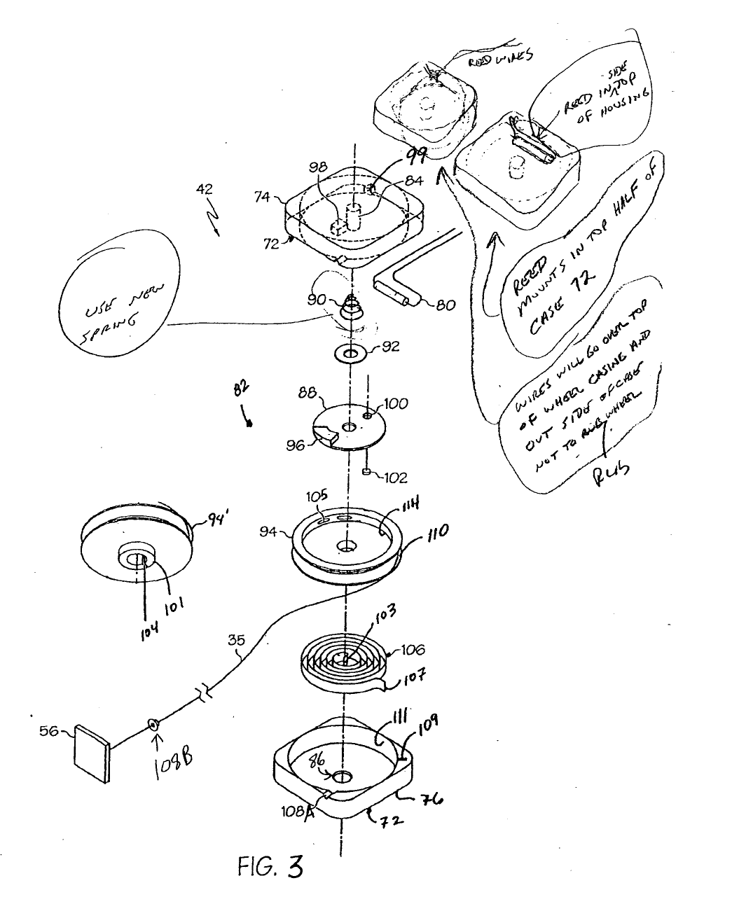

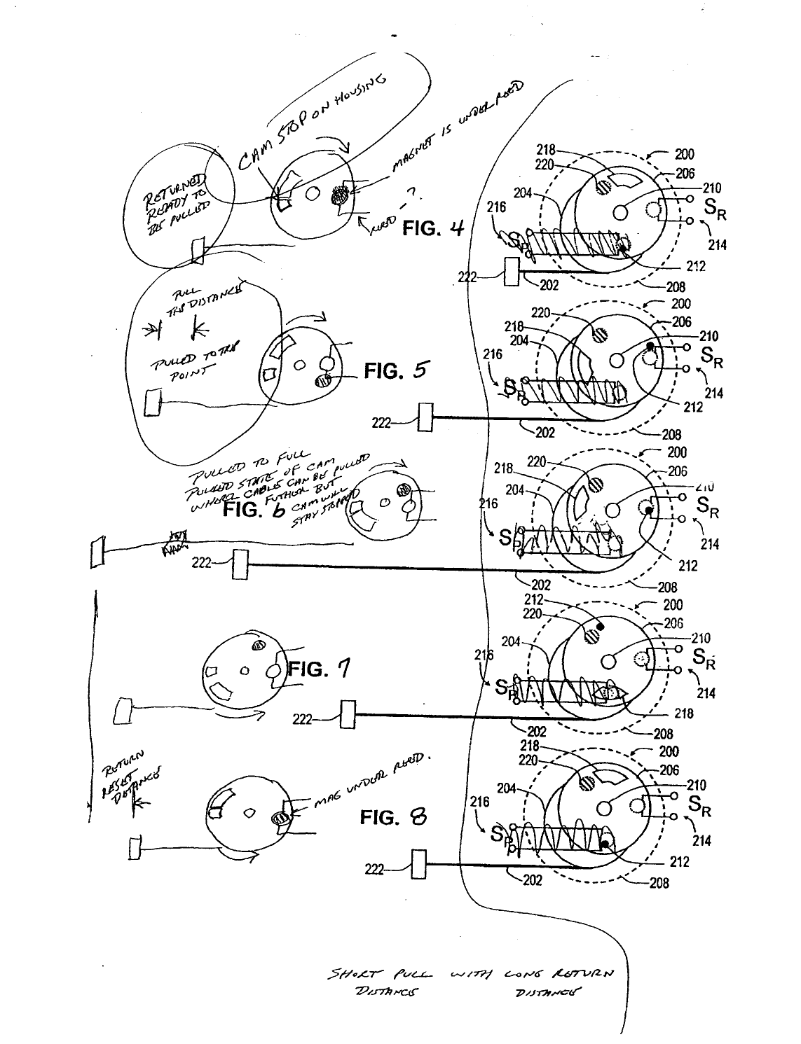

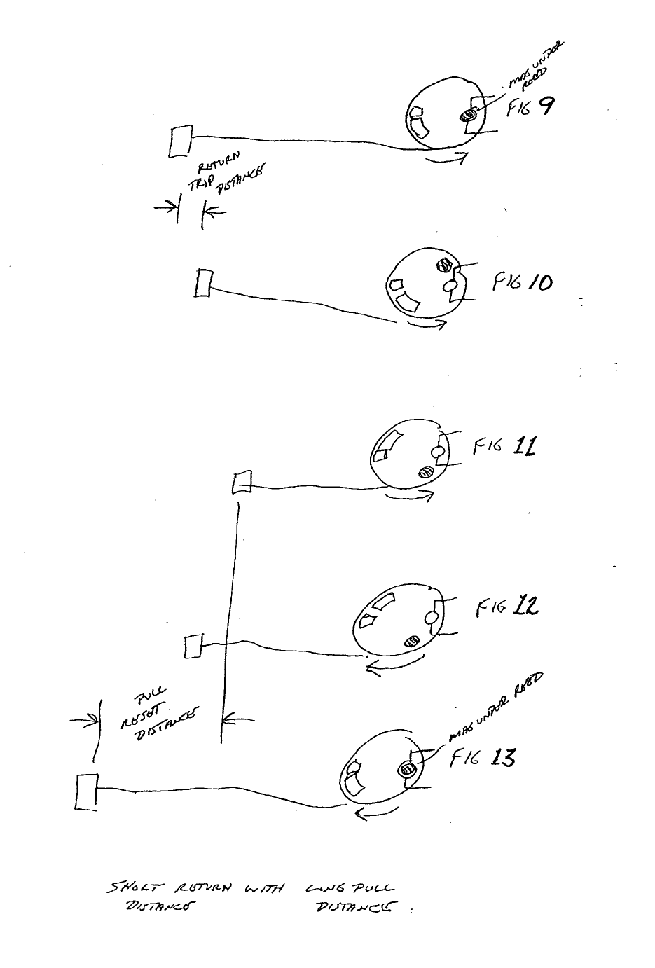

Examples of the switch functionalities include a pull version or a return version. Below are both versions explained in detail relating to disputes of cable pull and/or return and are depicted in FIGS. 3-13.

PULL EXAMPLE. When the pull string 35 is pulled from the pull switch 42, it may trip a N.O. and/or a N.C. internal reed 80 to its abnormal state within a given “short” distance such as, for example, 0.25 inches or any other suitable distance based on switch design. Any further pulling of the pull string 35 may not change the state of the reed 80. The maximum distance of the pull string 35 pull length may be about two feet or any other suitable length. The pull switch 42 may be reset, where the reed 80 is changed to its normal state, by retracting the pull string 35 into the pull switch 42 a given “long” distance such as, for example, 1.50 inches or any other suitable distance based upon switch design. Any further retracting of the pull string 35 may not change the state of the reed 80. It will be appreciated that the distance stated as “short” and the distance stated as “long” are only for reference and that actual distances may be designed to any suitable length. This, for example, may include the “short distance” being longer then the actual stated “long distance” and vice versa.

RETURN EXAMPLE. When the pull string 35 is retracted into the pull switch 42, it may trip a N.O. and/or a N.C. internal reed 80 to its abnormal state within a given “short” distance such as, for example, 0.25 inches or any other suitable distance based on switch design. Any further retraction of the pull string 35 may not change the state of the reed 80. The pull switch 42 may be reset, where the reed 80 is changed to its normal state, by pulling the pull string 35 a given “long” distance such as, for example, 1.50 inches or any other suitable distance based upon switch design. Any further pulling of the pull string 35 may not change the state of the reed 80. It will be appreciated that the distance stated as “short” and the distance stated as “long” are only for reference and that actual distances may be set to any suitable length. This, for example, may include the “short distance” being longer then the actual stated “long distance” and vice versa.

While the present invention has been illustrated by description of several embodiments and while the illustrative embodiments have been described in considerable detail, it is not the intention of the applicant to restrict or in any way limit the scope of the appended claims to such detail. Additional advantages and modifications may readily appear to those skilled in the art.

Applications of the switch 20 are numerous, including any applications where fixed contacts are applied.

While a reed sensor is depicted in the illustrative version, it should be appreciated that applications consistent with the present invention may include electrical contacts, microswitches, rotary encoder, proximity sensors, Hall effect sensors, LED,etc. that detect the pulled or returned condition of a pull switch.

What is claimed is:

1. A device, comprising:
a housing;
a reel encompassed for rotation within the housing;
a flexible member coiled about the reel;
a spring attached to the housing and to the reel biasing the reel for rotation in a first direction to coil the flexible member upon the reel;
a cam wheel frictionally engaged for rotation with the reel and comprising a cam wheel stop and a moving portion of a position sensor;
a fixed stop attached to the housing positioned to limit the rotation of the cam wheel within the housing; and
a fixed portion of the position sensor attached to the housing positioned to sense the moving portion at a selected rotational position of the cam wheel;
wherein pulling the flexible member out of the housing adjusts the corresponding length of the flexible member that corresponds to the selected rotational position of the cam wheel as the cam wheel is held as the reel is rotated.

2. The device of claim 1, wherein the movable portion of the position sensor comprises a magnet, the fixed portion of the position sensor comprises magnet sensing circuitry.

3. The device of claim 1, wherein the fixed portion of the position sensor comprises a reed switch.

4. The device of claim 1, wherein the position sensor is operatively configured to sense a pulled state of the flexible member.

5. The device of claim 1, wherein the position sensor is operatively configured to sense a returned state of the flexible member.

6. The device of claim 1, wherein the position sensor further comprises a plurality of fixed portions attached to the housing positioned to sense a plurality of positions of the movable portion of the position sensor.

7. The device of claim 6, further comprising a signal or contact (normally open and/or normally closed) output port of the device responsive to the position sensor.

8. The device of claim 7, wherein the pull switch comprises a pull-type sensor and a return-type sensor.
